(19) United States
(12) Patent Application Publication
(10) Pub. No.: US 2026/0184097 A1
(43) Pub. Date: Jul. 2, 2026

(54) BOOK COVER with nature graphic symbols

(71) Applicant: Claudiu Alexandru Giurgi, Bucharest (RO)

(72) Inventor: Claudiu Alexandru Giurgi, Bucharest (RO)

(21) Appl. No.: 18/407,569

(22) Filed: Jan. 9, 2024

(30) Foreign Application Priority Data
Nov. 22, 2023 (EM) 015040815-0001

(51) Int. Cl. B42D 3/00

(52) U.S. Cl. CPC B42D 3/08

(57) ABSTRACT

The present design relates to an ornamental surface pattern applied to a book cover. The design features a central motif with twig bearing leaves, framed by a decorative arrangement of plant and nature-inspired symbols, including flowers, leaves, mushrooms, and cacti, arranged within a rhombus-patterned background. The front cover incorporates an oval frame emphasizing the central twig, while the back cover features a rectangular frame around a similar central motif. The design is characterized by intricate detailing, a symmetrical layout, and an elegant, nature-themed aesthetic.

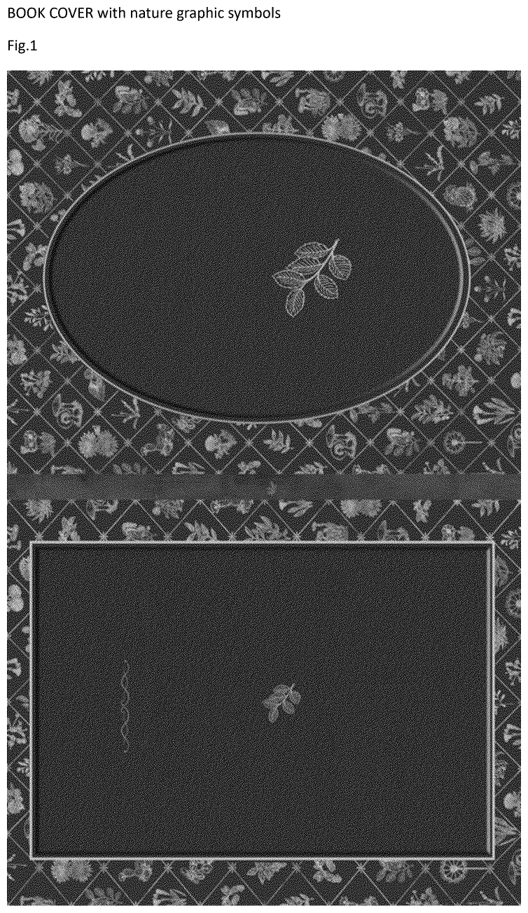

FIG. 1 is a spread elevational view of a surface pattern applied to a book cover showing my new design;

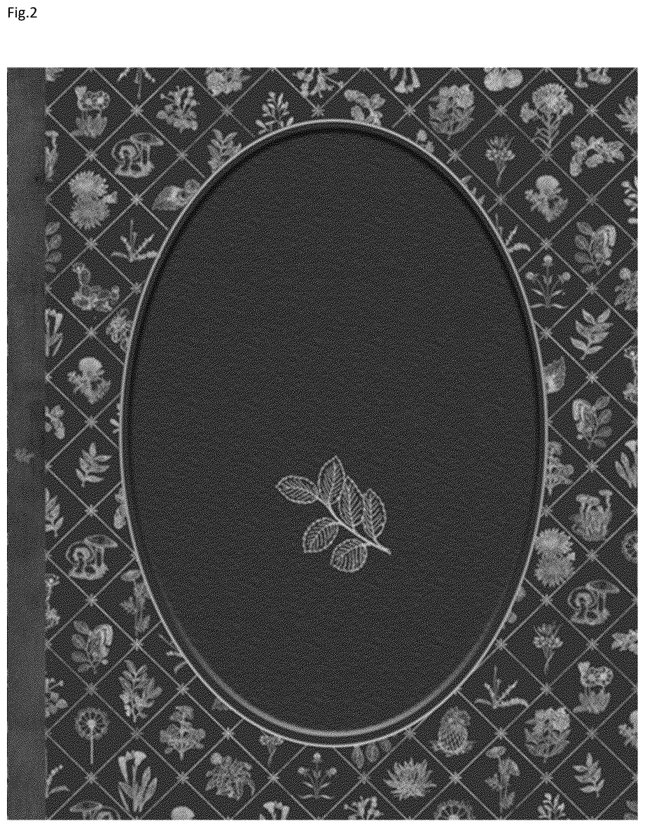

FIG. 2 is a front side elevational view of a central oval with a twig with leaves and framed by yellow-gold graphic symbols plants with or without flowers, leaves, flowers, twigs with leaves, mushrooms, cactus in rhombuses

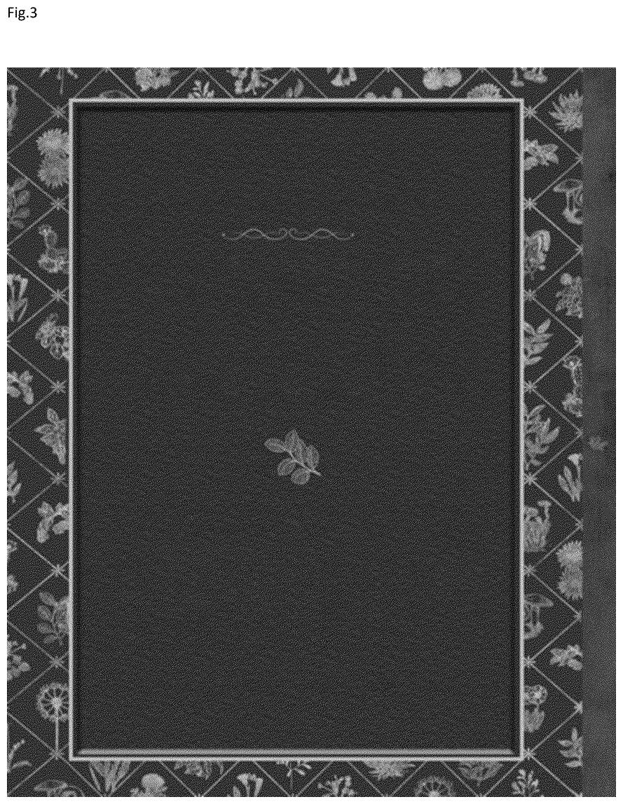

FIG. 3 is a back side elevational view of a central rectangle with a twig with leaves and framed by yellow-gold graphic symbols plants with or without flowers, leaves, flowers, twigs with leaves, mushrooms, cactus in rhombuses

1. I claim the ornamental design for a book cover as shown and described.
